(19) United States
(12) Patent Application Publication
(10) Pub. No.: US 2009/0035413 A1
(43) Pub. Date: Feb. 5, 2009

(54) STAND FOR A ROTARY TABLET PRESS

(75) Inventors: Frank Schade, Tramm (DE); Jan Naeve, Schattin (DE); Ulrich Arndt, Lauenburg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Fette GmbH, Schwarzenbek (DE)

(21) Appl. No.: 12/184,550

(22) Filed: Aug. 1, 2008

(30) Foreign Application Priority Data
Aug. 3, 2007 (DE) 10 2007 036 658.4

(51) Int. Cl. B30B 11/18

(52) U.S. Cl. 425/453

(57) ABSTRACT

A stand for a rotary tablet press, which supports a rotor with electric drive motor on a horizontal carrying element, with damping means between the stand and an underframe supporting itself on the ground for the purpose of vibration uncoupling between stand and underframe, wherein a first horizontal carrying element supports the rotor with the drive motor and a lower pressing roller unit of a least one pressing station, a second horizontal carrying element which is arranged in a distance above the first carrying element holds an upper pressing roller unit belonging to the pressing station, the first and the second carrying element are fixedly connected with each other via at least two vertical supports, and the supports rest on the underframe via damping means.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

When there is spoken of a tablet press below, this means a rotary press, by which pressed articles from powder material can be produced, which have not necessarily to be tablets, of course.

Usually, a rotary press contains a rotor with upper and lower punches, which co-operate with guiding cams and pressing stations. The pressing stations contain upper and lower rollers, which when passing the punches press the same in the direction against each other and with this against the material to be pressed in die holes of a die plate. The pressing rollers can be adjusted in the height. The rotor is driven by a suitable drive motor, wherein it has become known from DE 10 2004 040 163, the entire contents of which is incorporated herein by reference, to arrange a drive motor immediately below the rotor on the shaft of the rotor, or to integrate the drive motor into the rotor. In the latter case, it is dealt with an external rotor motor, and the stator sits on a pillar in the stand of the tablet press which also bearing mounts the rotor.

The rotor of the tablet press is operated with high rotational speed, through which the pressing punches on their part perform linear movements with a high speed. Through this, not insubstantial vibrations are generated, which if not damped are guided into the ground. In addition, there is a not insubstantial generation of noise.

From EP 0 856 395, the entire contents of which is incorporated herein by reference, a rotary tablet press has become known, in which a massive base board accommodating the rotor with its drive and the pressing roller unit is accommodated by the parent stand by means of elastic bearings. By doing so, the vibrations occurring during the pressing process and the dynamic forces and moments of the rotor drive which act from the pressing rollers on the pressing roller unit are taken up by the massive base board and are transferred to the parent stand in a damped condition.

The present invention is based on the objective to provide a construction which is assembled particularly simply and which meets the demands of the individual functions of the rotary press, in which the vibrations occurring in the operation of the rotary press are damped or uncoupled from the ground in a high extent, respectively.

### BRIEF SUMMARY OF THE INVENTION

In the present invention, there is provided a first horizontal carrying element, which supports the rotor together with the drive motor and a lower pressing roller unit of a least one pressing station. Above the first carrying element and in a distance to the same is arranged a second horizontal carrying element, on which the upper pressing roller unit of the pressing station is mounted, amongst others. In addition, the cam elements can be mounted on the upper carrying element, which are necessary for guiding the upper punches. Corresponding arrangements hold for the lower cam elements, which can be connected to the lower horizontal carrying element. The first and the second horizontal carrying element are fixedly connected with each other by at least two vertical supports, and these supports rest on the underframe via two damping means.

By the fact that upper and lower pressing roller unit are separated and are mounted on the lower and the upper carrying element, a stable frame results which is formed by the carrying elements and the lateral supports. As a consequence, it is advantageous to support only this frame on the underframe via damping elements, in order to keep the body noise away from the ground, which is generated by the pressing station above all.

According to one embodiment of the present invention, two diametrically opposing supports are provided, which each at a time are supported on the underframe via a pair of spaced apart damping means according to a further embodiment of the present invention.

According to a further embodiment of the present invention, the carrying elements have the outline of a polygon and are equal in the outline among each other. Preferably, the carrying elements are constituted by suitable grid- or frameworks with planar upper and lower sides. On their part, the carrying elements constitute housings for the accommodation of different aggregates, like for instance adjustment devices for pressing rollers, drive for the filling equipment, and drive for cams and so on.

According to a further embodiment of the present invention, the underframe has a base board, which rests on the ground via feet. According to a further embodiment of the present invention, a dome surrounding the stand can rest on the damped base board. The dome serves for damping the air noise.

### BRIEF DESCRIPTION OF THE SEVERAL VIEWS OF THE DRAWINGS

An example of the realisation of the present invention is explained in more detail by means of a drawing in the following.

FIG. 1 shows more or less schematically the stand of the present invention for a rotary tablet press in a perspective view.

FIG. 2 shows another embodiment of a pillar.

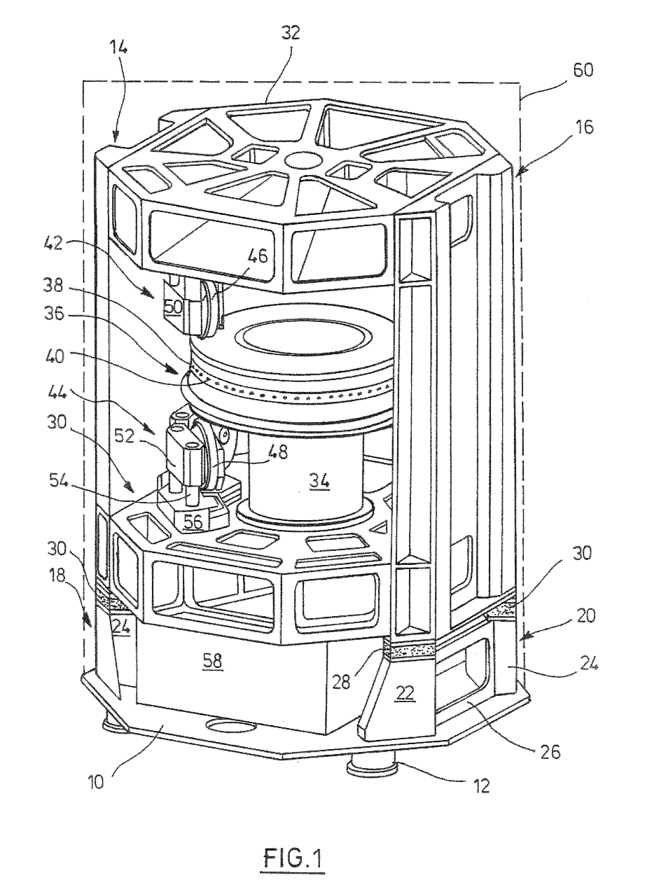

### In FIG. 1, a base board 10 rests on a ground via feet 12. The feet 12 may contain damping elements.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

On opposing sides of the base board 10 is arranged a underframe 18 or 20, respectively, with two pairs of spaced apart short pillar portions 22 or 24, respectively, which are connected to each other by a cross bridge 26, wherein the pairs are located diametrically opposing each other. Pillars 14, 16 rest on the underframe 18 or 20, respectively, namely via two damping elements 28, 30 one at a time. The pillars 14, 16 are approximately U-shaped in their horizontal sections, wherein the main supporting force is transferred by the limb portions which are trapezoid in their cross section and which are connected with each other by a thinner bridge portion. Between the pillars 14, 16 are arranged a lower carrying element 30 and an upper carrying element 32. The carrying elements 30, 32 constitute a kind of grid work, with planar upper and lower sides. They are octagonal in the outline, wherein the pillars 14, 16 extend across one side of the octagon and are connected to the same by suitable means, by screwing for instance. The carrying elements 30, 32 are equal in their outline. The lower carrying element 30 is arranged in a certain distance above the base board 10 and bears a pillar 34 in its centre, on which a rotor 36 for a tablet press is rotatably mounted. Amongst others, the rotor contains a die plate 38 with die holes 40, as is per se known. Upper and lower punches, which are guided in the rotor above and below the die plate 38, are neglected due to reasons of better representation. The upper and lower punches co-operate with an upper pressing roller unit 42 or a lower pressing roller unit 44, respectively. They have at least one pressing roller 46 and 48, respectively, which are rotatably mounted in a suitable bearing part 50 or 52, respectively, which is executed to be fork-shaped. The fork-shaped bearing parts 50, 52 are vertically guided by pillar-like guidings 52, as can be recognised for the bearing part 52 in particular. The pillars 54 are held by suitable holding devices, from which the lower one is shown at 56. The holding devices 56 are fixed on the lower carrying element 30 and on the upper carrying element 32, respectively. In this way, the pressing force of the rollers 46, 48 can be introduced axially into the upper and lower punches, without that excessive deformations take place.

An electric drive motor which cannot be seen is integrated into the rotor 36. Its armature situated on the outside is connected to the rotor 36 in a torsionally fixed manner, whereas the stator is fixedly connected to the pillar 34. The mounting of the rotor 36 on the pillar 34 can also not be seen.

Below the lower carrying element 30 towards the base board 10, a clearance is provided, in which a switch cabinet 58 for the shown tablet press is accommodated.

Upper and lower carrying elements 30, 32 and pillars 14, 16 constitute a stable frame, which receives all the forces and vibrations generated by the shown rotary tablet press. The generated body noise of the frame is damped by the four damping elements 28, 30, so that the base board 20 is almost free from vibrations and transmits relatively few vibrations into the ground.

A dome 60 (drawn in dashed lines) rests on the base board 10 and surrounds the whole stand. The dome 60 damps the air noise which is generated by the tablet press.

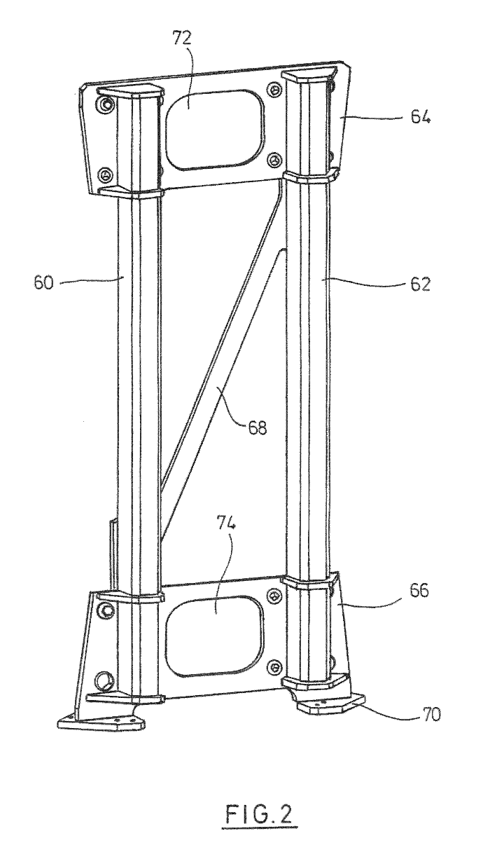

The pillar according to FIG. 2 has two parallel spaced apart supports 60, 62 with square cross sections, which are connected to each other by cross boards 64, 66 at the upper and lower sides. They are also connected by a diagonal tie 68. The boards 64, 66 are laterally connected with the platforms 32, 30 according to FIG. 1. Foot plates 70 are connected to the damping elements 28, 30 according to FIG. 1. Openings 72, 74 in the boards 64, 66 which are comparable to the not indicated openings in FIG. 1 permit to reach through into the interior of the platforms 30, 32.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A stand for a rotary tablet press, which supports a rotor with electric drive motor on a horizontal carrying element, with damping means between the stand and an underframe supporting itself on the ground for the purpose of vibration uncoupling between stand and underframe, characterised in that a first horizontal carrying element (30) supports the rotor (36) with the drive motor and a lower pressing roller unit (44) of a least one pressing station, a second horizontal carrying element (32) which is arranged in a distance above the first carrying element (30) holds an upper pressing roller unit (42) belonging to the pressing station, the first and the second carrying element (30, 32) are fixedly connected with each other via at least two vertical supports (14, 16), and the supports (14, 16) rest on the underframe (18, 20) via damping means (28, 30).

2. A stand according to claim 1, characterised in that two diametrically opposing supports (14, 16) are provided.

3. A stand according to claim 1, characterised in that both carrying elements (30, 32) are equal in their outline and polygonal.

4. A stand according to claim 3, characterised in that the supports (14, 16) are connected with one side of the polygon.

5. A stand according to claim 1, characterised in that the supports (14, 16) are supported on the underframe (18, 20) via a pair of spaced apart damping elements (28, 30).

6. A stand according to claim 1, characterised in that the carrying elements (30) are constituted by a grid- or framework with a planar upper and lower side.

7. A stand according to claim 1, characterised in that the underframe (18, 20) has a base board (10), which rests on the ground via feet (12).

8. A stand according to claim 7, characterised in that a sound absorbing dome (60) lapped over the stand rests on the base board (10).
